(19) United States
(12) Patent Application Publication
(10) Pub. No.: US 2026/0147495 A1
(43) Pub. Date: May 28, 2026

(54) MEMORY PACKAGE INCLUDING PLURALITY OF STORAGE DEVICES, OPERATION METHOD OF THE MEMORY PACKAGE, AND MEMORY CONTROLLER

(71) Applicant: Samsung Electronics Co., Ltd., Suwon-si (KR)

(72) Inventors: Yull KIM, Suwon-si (KR); Suhwa YOO, Suwon-si (KR); Jungmin BAE, Suwon-si (KR)

(73) Assignee: Samsung Electronics Co., Ltd., Suwon-si (KR)

(21) Appl. No.: 19/387,941

(22) Filed: Nov. 13, 2025

(30) Foreign Application Priority Data
Nov. 25, 2024 (KR) 10-2024-0170059

(51) Int. Cl. G06F 3/06

(52) U.S. Cl. CPC G06F 3/0634; G06F 3/0614; G06F 3/0688

(57) ABSTRACT

A memory package includes a first storage device including a first controller configured to receive a first command, and a second storage device including a second controller configured to receive a second command. The first controller is configured to monitor a first background event of the first storage device, and, in response detecting the first background event, generate status information indicating detection of the first background event and transmit the status information to the second controller. The second controller is configured to receive the status information from the first controller, monitor a second background event of the second storage device based on the received status information, generate a response mode indicating either a boost mode or a throttling mode based on a result of the monitoring, and transmit the response mode to the first controller.

### CROSS-REFERENCE TO RELATED APPLICATION

This U.S. non-provisional application claims priority under 35 U.S.C. § 119 to Korean Patent Application No. 10-2024-0170059, filed on Nov. 25, 2024, in the Korean Intellectual Property Office, the disclosure of which is incorporated herein by reference in its entirety.

### BACKGROUND

Example embodiments of the inventive concepts relate to a memory package including a plurality of storage devices, and a method of operating the same.

Universal flash storages (UFSs) are storage interfaces that support high-speed data transmission, and may be used in compact electronic apparatuses, such as mobile apparatuses. According to the UFS 4.0 standard of the Joint Electron Device Engineering Council (JEDEC), which defines the standard specifications for UFS devices, connection between a host and an UFS device may be implemented in a 2-LANE manner.

Artificial intelligence (AI) technology and other technologies may benefit from processing increased amount of data in relatively shorter time. High transmission speeds used for AI model learning and real-time data processing may benefit by supporting 4-LANE that is obtained by configuring two UFS devices into a single package as an on-device solution.

### SUMMARY

Example embodiments of the inventive concepts provides synchronization of operations between a plurality of universal flash storage (UFS) storages in a memory package including the plurality of UFS storages.

The technical problems of the disclosure are not limited to the above-mentioned technical problems, and other technical problems not mentioned will be clearly understood by a person skilled in the art from the following description.

According to some example embodiments of the inventive concepts, a memory package including a first storage device including a first controller configured to receive a first command, and a second storage device including a second controller configured to receive a second command. The first controller is configured to monitor a first background event of the first storage device, and, in response to detecting the first background event, generate status information indicating detection of the first background event and transmit the status information to the second controller. The second controller is configured to receive the status information from the first controller, monitor a second background event of the second storage device based on the received status information, generate a response mode indicating either a boost mode or a throttling mode, based on a result of the monitoring, and transmit the response mode to the first controller.

According to some example embodiments of the inventive concepts, an operation method of a memory package includes receiving a first command for a first storage device included in the memory package and a second command for a second storage device included in the memory package, monitoring a first background event of the first storage device by a first controller of the first storage device, in response to detection of the first background event, generating status information indicating the detection of the first background event and transmitting the status information to a second controller of the first storage device, receiving the status information from the first controller by the second controller, monitoring a second background event of the second storage device based on the received status information, and, based on a result of the monitoring, generating a response mode indicating either a boost mode or a throttling mode and transmitting the response mode to the first controller.

According to some example embodiments of the inventive concepts, a memory controller incudes a processor configured to process a command, a background operation manager configured to monitor an occurrence of a background event, and a peer communicator configured to transmit status information indicating whether the background event has occurred, or to receive a response mode indicating either a boost mode or a throttling mode. The background operation manager is configured to generate state information and provide the state information, in response to detection of the background event, and preferentially process either the background event or the command according to the received response mode.

According to some example embodiments, a memory system includes a memory package, and a host communicably coupled to the memory package. The memory package includes a first storage device including a first controller configured to receive a first command, and a second storage device including a second controller configured to receive a second command. The first controller is configured to monitor a first background event of the first storage device, and, in response to detecting the first background event, generate status information indicating detection of the first background event and transmit the status information to the second controller. The second controller is configured to receive the status information from the first controller, monitor a second background event of the second storage device based on the received status information, generate a response mode indicating either a boost mode or a throttling mode based on a result of the monitoring, and transmit the response mode to the first controller.

### BRIEF DESCRIPTION OF THE DRAWINGS

Embodiments will be more clearly understood from the following detailed description taken in conjunction with the accompanying drawings in which:

FIG. 1 is a block diagram of a memory system according to some example embodiments.

FIG. 2 is a block diagram of a first controller according to some example embodiments.

FIG. 3 is a block diagram of a first synchronizer according to some example embodiments.

FIG. 4 is a diagram illustrating signal exchange of a memory system according to a comparative example.

FIG. 5A is a graph showing performance when a second storage device, according to a comparative example, performs a background operation first.

FIG. 5B is a graph showing performance when a first storage device, according to a comparative example, performs a background operation first.

FIG. 6 is a flowchart of a method of operation of a request memory according to some example embodiments.

FIG. 7 is a flowchart of a method of operation of a response memory according to some example embodiments.

FIG. 8A is a diagram illustrating signal exchange of a memory system in a boost mode, according to some example embodiments.

FIG. 8B is a graph showing performance changes in the boost mode, according to some example embodiments.

FIG. 9A is a diagram illustrating signal exchange of a memory system in a throttling mode, according to some example embodiments.

FIG. 9B is a graph showing performance changes in the throttling mode, according to some example embodiments.

FIG. 10 is a diagram illustrating signal exchange of a memory system in a throttling mode, according to some example embodiments.

FIG. 11 is a block diagram of a system including a storage device, according to some example embodiments.

FIG. 12A is a diagram illustrating a Redundant Array of Independent Disk (RAID) implementation according to some example embodiments.

FIG. 12B is a diagram illustrating a RAID implementation according to some example embodiments.

### DETAILED DESCRIPTION OF THE EXAMPLE EMBODIMENTS

Hereinafter, the example embodiments of the inventive concepts will be described more fully with reference to the accompanying drawings, in which example embodiments of the inventive concepts are shown. In the drawings, like elements are denoted by like reference numerals, and a repeated explanation thereof will not be given.

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element, value, and/or property is referred to as being the same as another element, value, and/or property, it should be understood that an element, value, and/or property is the same as another element, value, and/or property within a desired manufacturing or operational tolerance range (e.g., ±10%).

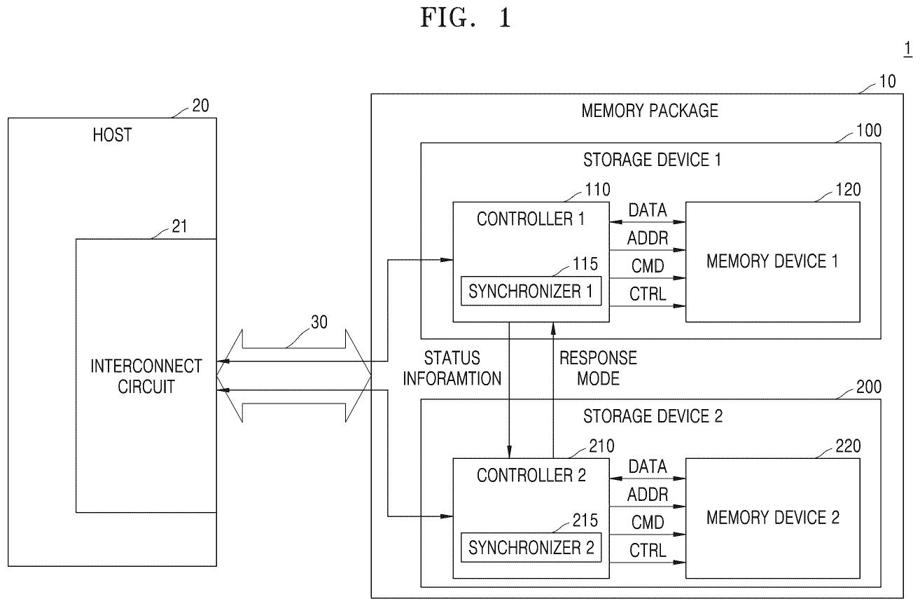

FIG. 1 is a block diagram of a memory system 1 according to some example embodiments.

Referring to FIG. 1, the memory system 1 may include a memory package 10 and a host 20.

The memory package 10 may include a first storage device 100 and a second storage device 200. In FIG. 1, the memory package 10 is illustrated as including two storage devices. However, the memory package 10 may include more than two storage devices. According to some example embodiments, the memory package 10 may be referred to as a storage system.

According to some example embodiments, the first and second storage devices 100 and 200 may be implemented as separate (or different) semiconductor chips, and may be mounted in the one memory package 10.

With respect to communication between the host 20 and the memory package 10, the memory system 1 may communicate using different types of interfaces. For example, the memory system 1 may communicate using different interfaces, such as a Universal Serial Bus (USB), a multimedia card (MMC), an embedded MMC (eMMC), a peripheral component Interconnection (PCI), a PCI-Express (PCI-E), an Advanced Technology Attachment (ATA), a Serial-ATA, a Parallel-ATA, a small computer small interface (SCSI), an enhanced small disk interface (ESDI), an Integrated Drive Electronics (IDE), a Firewire, a Nonvolatile Memory-express (NVMe), and a Universal Flash Storage (UFS).

The host 20 may include an interconnect circuit 21. The interconnect circuit 21 may provide an interface 30 between the host 20 and the memory package 10 including the first storage device 100 and the second storage device 200. The host 20 may transmit and receive data to and from the first and second storage devices 100 and 200 of the memory package 10 through the interconnect circuit 21. The interconnect circuit 21 may include physical and/or logical components for exchanging data with the host 20, and may include at least one receiver and at least one transmitter.

According to some example embodiments, the memory package 10 may be implemented as memory built into or removably attached to an electronic device. For example, the memory package 10 may be implemented in any of the different forms, such as an embedded UFS memory device, an eMMC, a solid state drive (SSD), a UFS memory card, a compact flash (CF), a secure digital (SD), a micro-SD, a mini-SD, an extreme Digital (xD), or a memory stick.

In some example embodiments below, it is assumed for the sake of discussion that a UFS interface is used in the memory system 1 and the host 20 and the first and second storage devices 100 and 200 generate and communicate packets (or data) according to the protocol of the UFS interface.

The first storage device 100 may include a first controller 110 (or first memory controller) and a first memory device 120. The second storage device 200 may include a second controller 210 (or second memory controller) and a second memory device 220.

In response to a read/write request from the host 20, the first controller 110 may control the first memory device 120 such that data is read from the first memory device 120 or written to the first memory device 120. The first controller 110 may provide the first memory device 120 with an address ADDR, a command CMD, and a control signal CTRL to control a write operation, a read operation, and an erasure operation on the first memory device 120. Write data DATA to be programmed and/or read-out data DATA may be transmitted or received between the first controller 110 and the first memory device 120. In response to a read/write request from the host 20, the second controller 210 may control the second memory device 220 such that data is read from the second memory device 220 or written to the second memory device 220. In detail, the second controller 210 may provide the second memory device 220 with an address ADDR, a command CMD, and a control signal CTRL to control a write operation, a read operation, and an erasure operation on the second memory device 220. Write data DATA to be programmed and/or read-out data DATA may be transmitted or received between the second controller 210 and the second memory device 220.

The first memory device 120 or the second memory device 220 may include a three-dimensional (3D) memory cell array that may include a plurality of NAND strings. Each of the plurality of NAND strings may include memory cells respectively connected to word lines vertically stacked on a substrate. However, example embodiments are not limited thereto. According to some example embodiments, the memory cell array may include a two-dimensional (2D) memory cell array, and the 2D memory cell array may include a plurality of NAND strings arranged in a column direction and a row direction. However, example embodiments are not limited thereto, and the memory cell array may include other types of non-volatile memory cells, such as resistive random access memory (ReRAM), phase change RAM (PRAM), or magnetic RAM (MRAM).

The first controller 110 and the second controller 210 may communicate between devices without using the host 20. Each of the first controller 110 and the second controller 210 may exchange a signal regarding status information and a signal regarding a response mode in order to achieve operation synchronization between the first controller 110 and the second controller 210. To this end, a first synchronizer 115 and a second synchronizer 215 may determine the status information and the response mode.

The status information may be information indicating that there is a background operation identified as being currently executed. For example, each of the first controller 110 and the second controller 210 may perform background operations to maintain the performance of a device, such as garbage collection (GC) and device thermal throttling (DTT), in parallel with performing a request received from the host 20. However, while the first storage device 100 and the second storage device 200 are only seen as a single memory package 10 to the host 20, the first storage device 100 and the second storage device 200 are independent memory devices. Therefore, time points at which the first storage device 100 and the second storage device 200 perform background operations, respectively, may be different from each other. Accordingly, the status information may be information used by a memory device that has identified a background operation to inform other memory devices of the identification of the background operation.

According to some example embodiments, the status information may be generated by a device that has identified the background operation (e.g., the first storage device 100 or the second storage device 200). For example, when the first controller 110 of the first storage device 100 determines that GC is to be performed (or is being performed), the first storage device 100 may generate the status information and provide the status information to the second storage device 200. As another example, when the second controller 210 of the second storage device 200 determines that DTT is to be performed (or is being performed), the second storage device 200 may generate the status information and provide the status information to the first storage device 100. The status information may be generated in the first storage device 100 and/or in the second storage device 200.

According to some example embodiments, pieces of status information may be distinguished from each other according to a value of an urgency indicator. The urgency indicator may be an indicator for indicating that there is a background operation that is to be currently being executed. For example, when a background operation is identified to be performed or when a background operation is identified as being performed, and it may not be possible to postpone the identified background operation (e.g., when performance degradation of the device or a malfunction thereof may occur if the background operation is not immediately performed or if the background operation is delayed or postponed), the urgency indicator may have a value of “1” or logic high. As another example, when a background operation has been identified to be performed but execution of the identified background operation may be postponed or delayed, the urgency indicator may have a value of “0” or logic low. A reason pieces of status information are distinguished from each other according to a value of the urgency indicator is that the pieces of status information are generated when (or only when) a background operation is identified to be performed. For example, when the first controller 110 is unable to identify a background operation that may be currently performed, the first controller 110 may not generate state information and transmit the state information to a peer storage device.

According to some example embodiments, the signal regarding the response mode may be a signal for synchronizing an operation mode of the first storage device 100 with that of the second storage device 200. When the first storage device 100 transmits the status information to the second storage device 200, the second storage device 200 may identify that there is a background operation being executed on the first storage device 100 at a current point in time. The second controller 210 may identify whether there is a background operation being executed (or to be executed) on the second storage device 200, and may determine a response mode according to a result of the identification. The response mode may be either a throttling mode or a boost mode. A criterion for throttling or boosting may be whether a request from the host 20 is processed first. For example, in the throttling mode, memory devices (e.g., the first storage device 100 and the second storage device 200) may first perform background operations, respectively. In the boosting mode, the memory devices (e.g., the first storage device 100 and the second storage device 200) may perform respectively received requests (or tasks) from the host 20 before performing the respective background operations.

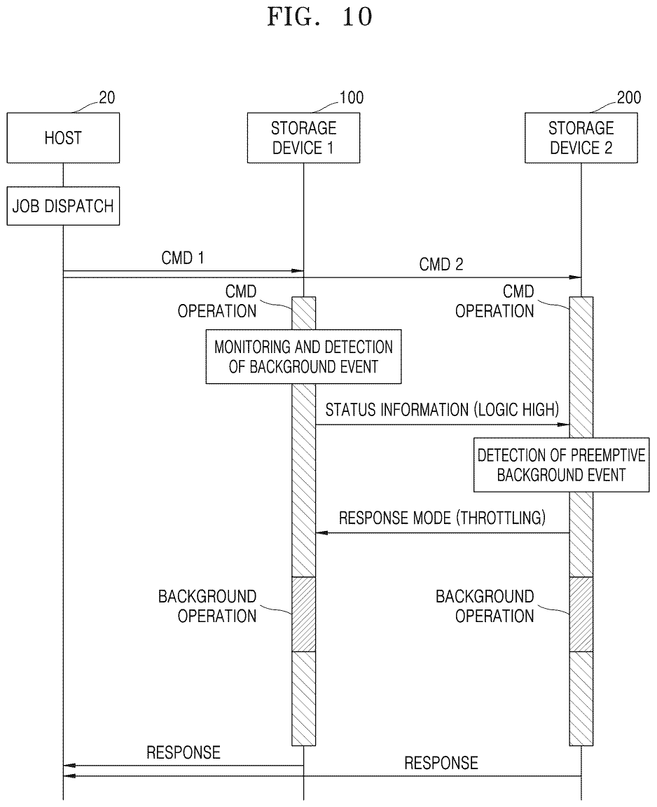

The throttling mode may be a mode when a background operation is identified in the second storage device 200. Because a background operation to be performed not only by the first storage device 100 but also by the second storage device 200 has been identified, the second storage device 200 may determine to process each background operation at the same time period (or zone or interval). The second storage device 200 may transmit, to the first storage device 100, a response mode of a throttling mode of temporarily postponing a command for processing a request received from the host 20 and preferentially processing a background operation. When the urgency indicator is “1” or logic high, it may not be possible to postpone the background operation of the first storage device 100, and thus the second storage device 200 may transmit the response mode of the throttling mode to the first storage device 100. A description of a case where the urgency indicator is logic high will be given below with reference to FIG. 10.

The boosting mode may be a mode when a background operation is not identified in the second storage device 200. The second storage device 200 may determine that there is a background operation to be currently performed by the first storage device 100 and there are no background operations that are to be performed by the second storage device 200. Accordingly, the second storage device 200 may transmit, to the first storage device 100, a response mode of a boosting mode of postponing a background operation of the first storage device 100 and preferentially processing a request received from the host 20.

According to the aforementioned status information and the aforementioned response mode, when a memory device requiring a background operation transmits status information, the memory device may return a response mode according to whether the remaining memory devices perform background operations, thereby limiting a background operation from being performed by only one memory device.

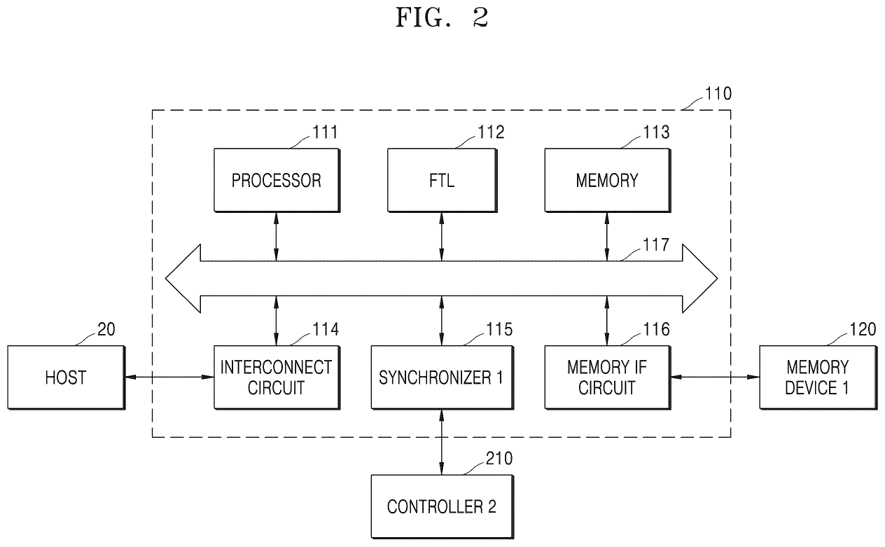

FIG. 2 is a block diagram of the first controller 110 according to some example embodiments. FIG. 2 may be described with reference to FIG. 1, and may be best understood with reference thereto.

Referring to FIG. 2, the first controller 110 may include a processor 111, a flash translation layer (FTL) 112, a memory 113, an interconnect circuit 114, a first synchronizer 115, and a memory interface (IF) circuit 116, which communicate with each other via a bus 117.

The processor 111 may include a central processing unit or a micro-processor, and may control the overall operation of the first controller 110. The processor 111 may include one or more processor cores that execute a set of instructions of program code configured to perform a desired operation. For example, the processor 111 may execute command code of firmware stored in the memory 113.

The FTL 112 may perform several functions, such as address mapping, wear-leveling, and garbage collection (GC). The address mapping is an operation of changing a logical address received from a host into a physical address used to store data in the first memory device 120. The wear-leveling is technology for limiting or reducing deterioration of a given block by enabling blocks within the first memory device 120 to be used uniformly, and may be implemented, for example, through firmware technology of balancing erase counts of physical blocks. The GC is technology for securing an available capacity within the first memory device 120 by using a method of copying valid data of a block to a new block and then erasing an existing block.

The memory 113 may be used as an operation memory, a buffer memory, a cache memory, or the like. For example, the memory 113 may be implemented as dynamic random access memory (DRAM), static random access memory (SRAM), phase-change random access memory (PRAM), or flash memory.

The interconnect circuit 114 may provide an interface (IF) between the host 20 and the first controller 110. For example, the interconnect circuit 114 may provide a USB, an MMC, a PCI-E, an ATA, a Serial AT Attachment (SATA), a Parallel AT Attachment (PATA), a SCSI, a Serial Attached SCSI (SAS), an ESDI, or an IF based on IDE or the like. The interconnect circuit 114 may receive requests and data from the host 20, and may output the data to the host 20.

The first synchronizer 115 may monitor the first storage device 100, generate status information to the second controller 210 based on a result of the monitoring, and provide the generated status information to the second storage device 200. For example, the first synchronizer 115 may monitor whether GC is performed based on the number of free blocks and a valid page count (VPC) value. The first synchronizer 115 may monitor whether device thermal throttling (DTT) is performed based on a temperature value provided by a temperature sensor. The first synchronizer 115 may generate status information including an urgency indicator. For example, when the number of free blocks and the VPC value satisfy GC execution conditions or the temperature value exceeds a threshold temperature value, the first synchronizer 115 may determine that a background operation of GC or DTT may not be postponed. In response to the determination, the first synchronizer 115 may generate the status information by setting the urgency indicator to be “1” or logic high. As another example, when the number of free blocks and the VPC value satisfy GC execution conditions or the temperature value is less than the threshold temperature value, the first synchronizer 115 may determine that a background operation of GC or DTT may be postponed. In response to the determination, the first synchronizer 115 may generate the status information by setting the urgency indicator to be “0” or logic low.

The first synchronizer 115 may monitor the first storage device 100, determine a response mode, based on a result of the monitoring and the status information received from the second storage device 200, and return the response mode to the second controller 210. For example, the status information received from the second storage device 200 may include an urgency indicator of “0” or logic low. The first synchronizer 115 may monitor the VPC value. When the number of free blocks and the VPC value satisfy the GC execution conditions, the first synchronizer 115 may perform GC, and may transmit a response mode indicating a throttling mode to the second storage device 200. Alternatively, the first synchronizer 115 may monitor the temperature value. When the temperature value exceeds the threshold temperature value, the first synchronizer 115 may perform DTT, and may transmit a response mode indicating a throttling mode to the second storage device 200. As another example, the status information received from the second storage device 200 may include an urgency indicator of “1” or logic high. The first synchronizer 115 may transmit a response mode indicating a throttling mode to the second storage device 200, based on the urgency indicator. As for an urgency indicator of logic high, the first synchronizer 115 may determine the throttling mode regardless of a result of monitoring a background operation. Thereafter, the first synchronizer 115 may determine to perform background operations such as early GC and Host controlled Garbage Collection (HCGC).

The memory IF circuit 116 may provide an interface between the first controller 110 and the first memory device 120. For example, the data DATA of FIG. 1, the command CMD of FIG. 1, the address ADDR of FIG. 1, and the control signal CTRL of FIG. 1 may be transmitted or received between the first controller 110 and the first memory device 120 via the memory IF circuit 116.

The bus 117 may operate based on one of various bus protocols. The various bus protocols may include at least one of an Advanced Microcontroller Bus Architecture (AMBA) protocol, a USB protocol, an MMC protocol, a PCI protocol, a PCI-E protocol, an ATA protocol, a Serial-ATA protocol, a Parallel-ATA protocol, a SCSI protocol, an ESDI protocol, an IDE protocol, a Mobile Industry Processor Interface (MIPI) protocol, and a UFS protocol. The second controller 210 may be the same as or similar in some respects to the first controller 110, and therefore may be best understood with reference thereto.

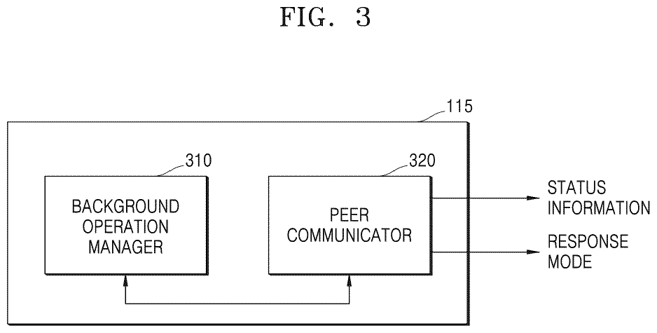

FIG. 3 is a block diagram of the first synchronizer 115 according to some example embodiments. FIG. 3 may be described with reference to FIGS. 1 and 2, and may be best understood with reference thereto.

Referring to FIG. 3, the first synchronizer 115 may include a background operation manager 310 and a peer communicator 320.

The background operation manager 310 may perform monitoring of a background event. The monitoring may be performed periodically by the background operation manager 310 at desired time intervals (e.g., at regular or irregular intervals), or may be performed in response to receiving status information from a peer memory device. The peer memory may refer to another storage device (e.g., the second storage device 200) included together in the memory package 10.

According to some example embodiments, the background operation manager 310 may monitor a GC event. The background operation manager 310 may determine whether to perform GC, based on the number of free blocks of the first memory device 120 and a VPC value per block. As another example, the background operation manager 310 may monitor a DTT event. The background operation manager 310 may determine whether to perform a DTT event based on a temperature value of the first storage device 100. The background operation manager 310 may provide a result of the monitoring to the peer communicator 320.

The peer communicator 320 may perform communication with the peer memory device. The peer communicator 320 may transmit status information to the peer memory device or may transmit a response mode to the peer memory device. The peer communicator 320 may be dedicated only for communication with the peer memory device.

According to some example embodiments, the peer communicator 320 may transmit status information to the peer memory device. When a background event is detected, the peer communicator 320 may generate and transmit status information for notifying the peer memory of detection of the background event. For example, the background operation manager 310 may determine whether to perform GC or DTT in the first storage device 100. In response to the determination, the peer communicator 320 may transmit status information to a peer communicator of the second storage device 200 (e.g., a peer communicator included in the second synchronizer 215 of FIG. 1 and the second controller 210 of FIG. 2).

The peer communicator 320 may transmit a response mode to the peer memory. According to some example embodiments, the peer communicator 320 may receive status information from the peer communicator of the second storage device 200. In response to reception of the status information, the background operation manager 310 may perform monitoring of a background event. When no background events are detected, the second storage device 200 (e.g., only the second storage device) may need a background operation and the first storage device 100 may not perform a background operation, so the peer communicator 320 may transmit a response mode indicating a boost mode to the peer memory. When a background event is detected, both the second storage device 200 and the first storage device 100 may perform background operations, so the peer communicator 320 may transmit a response mode indicating a throttling mode to the peer memory.

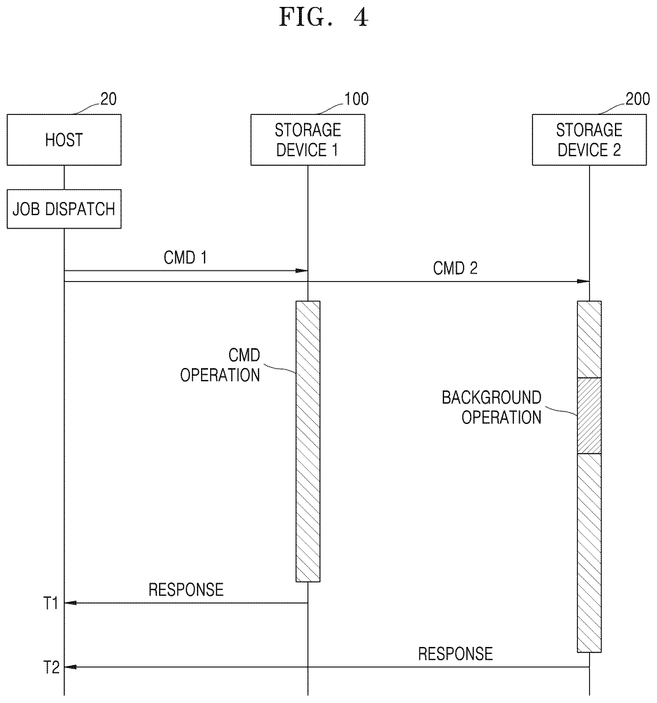

FIG. 4 is a diagram illustrating signal exchange of the memory system 1 according to a comparative example.

Referring to FIG. 4, a comparative example is shown in which the first storage device 100 and the second storage device 200 include no synchronizers (e.g., the first synchronizer 115 of FIG. 1 and the second synchronizer 215 of FIG. 1). Because the first synchronizer 115 and the second synchronizer 215 are absent, the first storage device 100 and the second storage device 200 may not communicate status information and/or a response mode with each other.

The host 20 may transmit commands to the first storage device 100 and/or the second storage device 200. Because the memory package 10 is seen as a single entity at a kernel end of the host 20, the host 20 may issue only a single job dispatch to one memory. However, a file system end of the host 20 may separate and transmit commands according to addresses. For example, at the file system end, a first command CMD 1 corresponding to an address of the first storage device 100 among requests of the host 20 may be generated and transmitted for the first storage device 100, and a second command CMD 2 corresponding to an address of the second storage device 200 among the requests of the host 20 may be generated and transmitted for the second storage device 200.

The second storage device 200 may perform a background operation. The host may view the first storage device 100 and the second storage device 200 as a single memory package 10, however, the first storage device 100 and the second storage device 200 are different (or separate) storage devices, and background operations may be performed separately. For example, the second controller 210 of the second storage device 200 may determine to perform GC, based on the number of free blocks and a VPC value per block. Alternatively, the second controller 210 may determine to perform DTT based on a temperature of the second storage device 200 exceeding a threshold temperature. Accordingly, the second storage device 200 may temporarily postpone processing of the second command CMD 2 received from the host 20, and may preferentially perform a background operation. After the background operation is completed, the second storage device 200 may process the second command CMD 2 again, and a completion time point of the second command CMD 2 may be a second time point T2.

The first storage device 100 may process the first command CMD 1 received from the host 20 without performing a background operation. For example, the first controller 110 of the first storage device 100 may not perform GC, based on the number of free blocks and a VPC value per block. Alternatively, because the temperature of the first storage device 100 is less than the threshold temperature, the first controller 110 of the first storage device 100 may not perform DDT. Because the first storage device 100 processes only the first command CMD 1 without performing a background operation, a completion time point of the first command CMD 1 may be a first time point T1. The first time point T1 may precede a second time point T2.

Because the host 20 only issues a single job dispatch to the memory package 10, the file system end may wait until the file system end receives responses from both the first storage device 100 and the second storage device 200. The file system end may complete job dispatch by receiving responses from both the first storage device 100 and the second storage device 200, combining them, and transmitting a result of the combination to the kernel end of the host 20.

As described above, because the second storage device 200 independently performs a background operation and thus the completion time point of the second command CMD 2 is postponed to the second time point T2, an inefficiency period may occur from the first time point T1 to the second time point T2. When the second storage device 200 has postponed the second command CMD 2 for a time period and has preferentially processed the background operation, although a job dispatch is able to be completed at the first time point T1, the second storage device 200 may independently perform a background operation. Thus, it may be seen that the completion time point of the job dispatch is postponed or delayed.

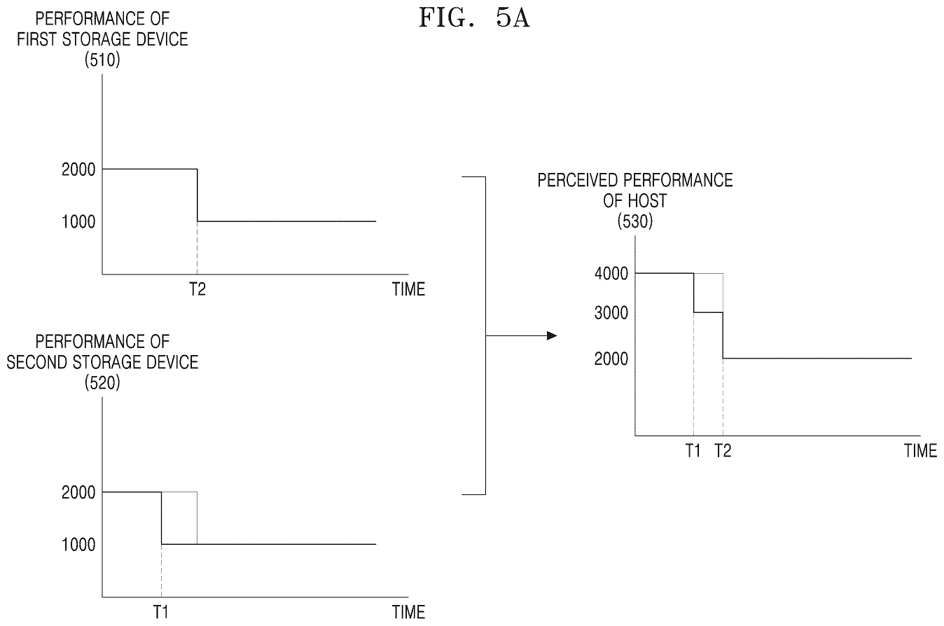

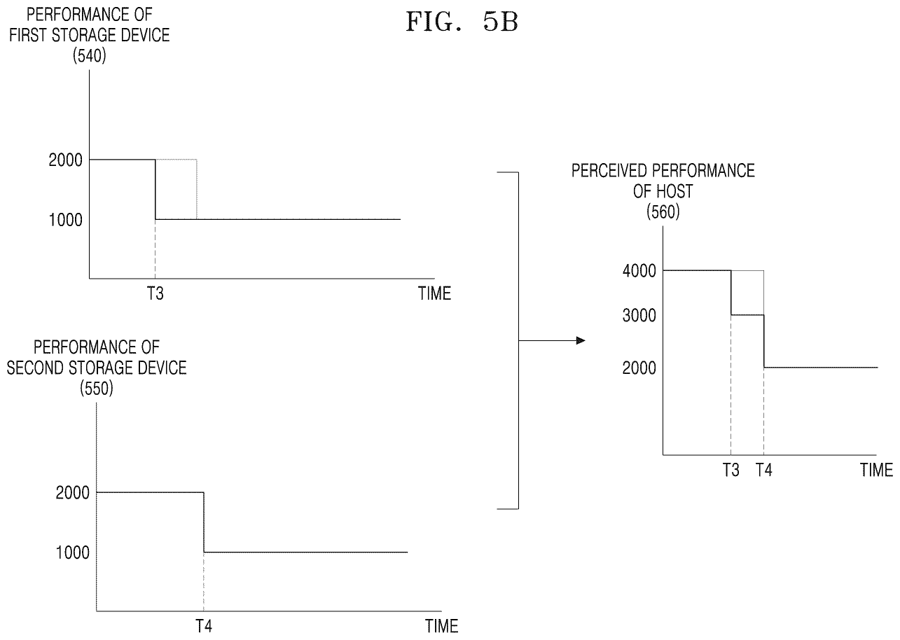

FIG. 5A is a graph showing performance when the second storage device 200 according to a comparative example performs a background operation first, and FIG. 5B is a graph showing performance when the first storage device 100 according to a comparative example performs a background operation first.

Referring to FIGS. 5A and 5B, the first storage device 100 and the second storage device 200 may perform respective background operations. For example, referring to FIG. 4 together with FIGS. 5A and 5B, the first storage device 100 may perform the first command CMD 1 and then perform a background operation (e.g., GC or DTT), and the second storage device 200 may perform the background operation and then perform the second command CMD 2.

Referring to FIG. 5A, performances (e.g., a throughput, a read/write bandwidth, a maximum bandwidth, or an input/output operation per second (IOPS)) of the first storage device 100 and the second storage device 200 may be reduced with entry into the background operation. For example, referring to a graph 510 regarding the performance of the first storage device 100 and a graph 520 regarding the performance of the second storage device 200, each of the performances may be 2000 while a command received from the host 20 is being processed, and may be 1000 while a background operation is being performed.

The second storage device 200 may perform a background operation at the first time point T1, and the first storage device 100 may perform a background operation at the second time point T2. The performance of the memory package 10, perceived by the host 20, may be the sum of the performance of the first storage device 100 and the performance of the second storage device 200. Referring to a graph 530 regarding a host's perceived performance, the performance decreases from 4000 to 3000 at the first time point T1 when the second storage device 200 first enters the background operation, and the performance decreases from 3000 to 2000 at the second time point T2 when the first storage device 100 then enters the background operation. Each time the storage devices within the memory package 10 enter the background operation, a step-by-step performance degradation may occur, which may be seen as a performance fluctuation, leading to deterioration in the operation consistency and I/O consistency of the memory package 10.

Referring to a graph 540 of FIG. 5B regarding the performance of the first storage device 100 and a graph 550 of FIG. 5B regarding the performance of the second storage device 200, each of the performances may be 2000 while a command received from the host 20 is being processed, and may be 1000 while a background operation is being performed.

The first storage device 100 may perform a background operation at a third time point T3, and the second storage device 200 may perform a background operation at a fourth time point T4. The performance of the memory package 10, perceived by the host 20, may be the sum of the performance of the first storage device 100 and the performance of the second storage device 200. Referring to a graph 560 regarding a host's perceived performance, the performance decreases from 4000 to 3000 at the third time point T3 when the first storage device 100 first enters the background operation, and the performance decreases from 3000 to 2000 at the fourth time point T4 when the second storage device 200 then enters the background operation. Each time the storage devices within the memory package 10 enter the background operation, a step-by-step performance degradation may occur, which may be seen as a performance fluctuation, leading to deterioration in the operation consistency and I/O consistency of the memory package 10.

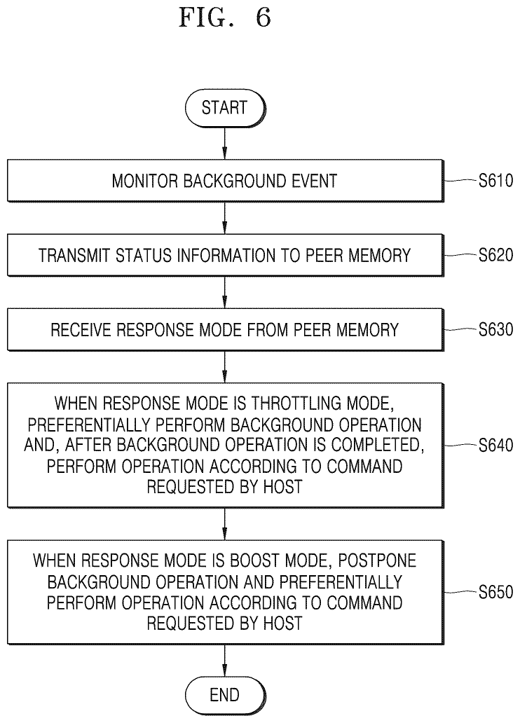

FIG. 6 is a flowchart of a method of operation of a request memory according to some example embodiments. It is understood that additional operations can be provided before, during, and after the operations in FIG. 6, and some of the operations described below can be replaced or eliminated, for additional embodiments of the method. The order of the operations/processes may be interchangeable, or two or more operations can be performed simultaneously.

Referring to FIG. 6, the request memory may refer to a memory that first identifies a background event and generates status information from either the first storage device 100 or the second storage device 200.

In operation S610, the request memory may monitor the background event. For example, the request memory may monitor whether GC needs to be performed based on the number of free blocks and a VPC value per block or whether DTT needs to be performed based on a temperature value. When it is determined that the background operation does not need to be performed, monitoring of a background event may be repeated without generating status information.

In operation S620, the request memory may transmit the status information to the peer memory. The request memory may have determined that the background operation is to be performed in operation S610. The request memory may generate the status information based on the identified background event. For example, when DTT is to be performed based on a temperature value exceeding a threshold temperature value, the request memory may generate status information including an urgency indicator of logic high. As another example, when it is determined that GC is to be performed based on the number of free blocks and a VPC value per block, the request memory may generate status information including an urgency indicator of logic low. Thereafter, the request memory may transmit the generated status information to the peer memory. The peer memory may refer to the remaining storage device except for the request memory from among the storage devices included in the memory package 10.

In operation S630, the request memory may receive a response mode from the peer memory. The response mode may indicate either a throttling mode or a boost mode.

In operation S640, when the response mode is a throttling mode, the request memory may preferentially perform a background operation, and, after the background operation is completed, may perform an operation according to the command requested by the host 20.

In operation S650, when the response mode is a boost mode, the request memory may postpone a background operation, and may preferentially perform an operation according to the command requested by the host 20. After having completed the operation according to the command requested by the host 20, the request memory may perform the postponed background operation.

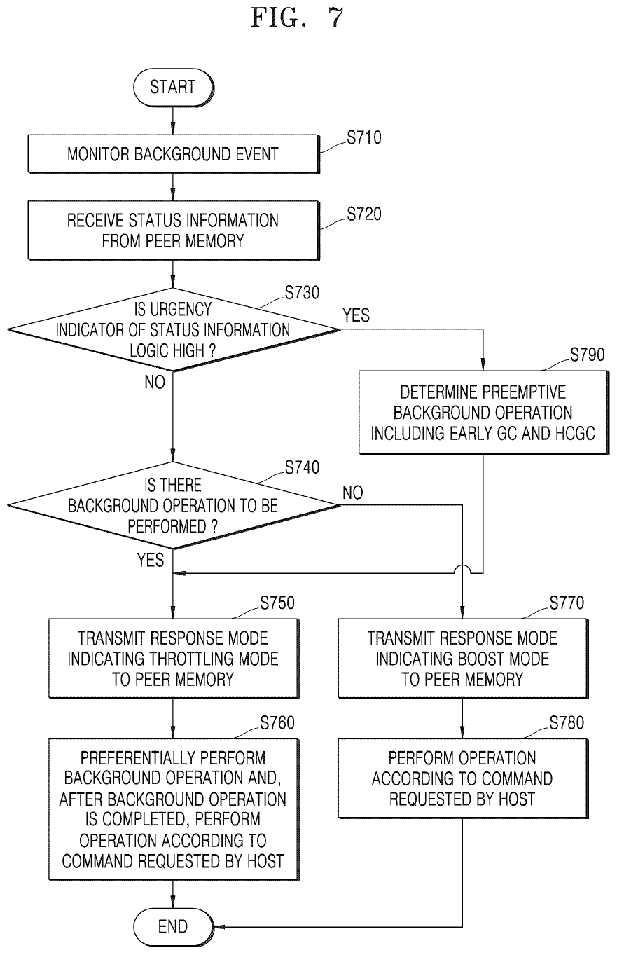

FIG. 7 is a flowchart of a method of operation of a response memory according to some example embodiments. It is understood that additional operations can be provided before, during, and after the operations in FIG. 7, and some of the operations described below can be replaced or eliminated, for additional embodiments of the method. The order of the operations/processes may be interchangeable, or two or more operations can be performed simultaneously.

Referring to FIG. 7, the response memory may refer to a memory that returns a response mode according to either a throttling mode or a boost mode in response to reception of status information.

In operation S710, the response memory may monitor a background event. For example, the response memory may monitor whether GC is to be performed based on the number of free blocks and a VPC value per block or whether DTT is to be performed based on a temperature value. When it is determined that background may not be performed, the monitoring of the background event may be repeated without generating the status information.

In operation S720, the response memory may receive the status information from the peer memory. The peer memory may refer to the remaining storage device except for the response memory from among the storage devices included in the memory package 10. The response memory may be in a state of being unable to detect the background event until receiving the state information from the peer memory.

In operation S730, the response memory may determine whether the urgency indicator of the status information is logic high. When the urgency indicator is logic high, the response memory may determine that the background operation identified by the peer memory (e.g., the request memory of FIG. 6) has a non-deferrable property. When the urgency indicator is logic high, the response memory may perform operation S790. When the urgency indicator is logic low, the response memory may determine that the background operation identified by the peer memory has a deferrable property.

In operation S740, the response memory may determine that there is a background operation to be performed. For example, the response memory may monitor whether GC is to be performed based on the number of free blocks and a VPC value per block or whether DTT is to be performed based on a temperature value. When the response memory determines that the background may not be performed, the response memory may perform operation S770, and, when the response memory determines that the background is to be performed, the response memory may perform operation S750.

In operation S750, the response memory may transmit a response mode indicating a throttling mode to the peer memory. When a background event is detected in operation S740, the response memory may perform the background operation detected in operation S740 while the peer memory is performing the detected background operation, thereby reducing the inefficiency period of FIG. 4. Accordingly, the response memory may transmit the response mode indicating the throttling mode to the peer memory.

In operation S760, the response memory may preferentially perform a background operation based on the throttling mode, and, after the background operation is completed, may perform an operation according to the command requested by the host 20. Not only the response memory but also the peer memory may preferentially perform background operations based on the response mode of the throttling mode. Because both the peer memory and the response memory preferentially perform background operations, the inefficiency period that occurs when only one of the peer memory and the response memory performs a background operation may be reduced.

In operation S770, the response memory may transmit a response mode indicating a boost mode to the peer memory. When no background events are detected in operation S740, the response memory may transmit, to the peer memory, a response mode of the boost mode for requesting the peer memory to postpone the background operation.

In operation S780, the response memory may perform an operation according to a command requested by the host 20. Because no background events have been detected in operation S740, there is no background operation that the response memory is to perform separately. Accordingly, the response memory may perform the operation according to the command requested by the host 20. Because the peer memory postpones a background operation and preferentially performs the command received from the host 20 according to the response mode of the boost mode received from the response memory, the inefficiency period that occurs when only one of the peer memory and the response memory performs a background operation may be reduced.

In operation S790, the response memory may determine a preemptive background operation including early GC and HCGC. Because the urgency indicator has been identified as logic high in operation S730, the response memory is unable to force the peer memory into the boost mode. Therefore, the response memory may determine a background operation that the response memory is to preemptively perform while the peer memory is performing the background operation. For example, even when it is determined that GC may be delayed or postponed based on the number of free blocks and a VPC value per block, the response memory may perform early GC. As another example, the response memory may perform HCGC for sequentially rewriting pieces of data distributed and written to several blocks. When the response memory determines, in operation S790, a preemptive background operation to be performed by the response memory while the peer memory is performing a background operation, the operation of the response memory may proceed to operation S750 to transmit the response mode of the throttling mode to the peer memory.

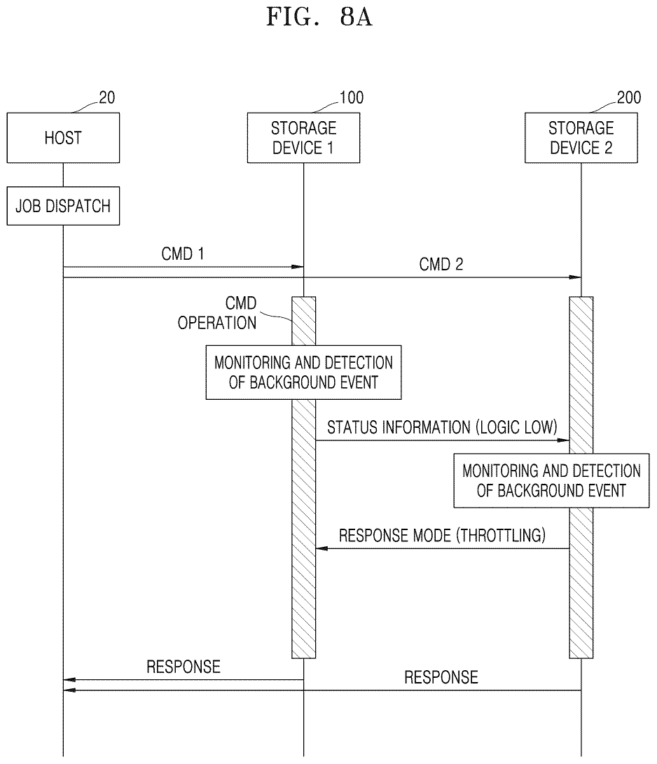

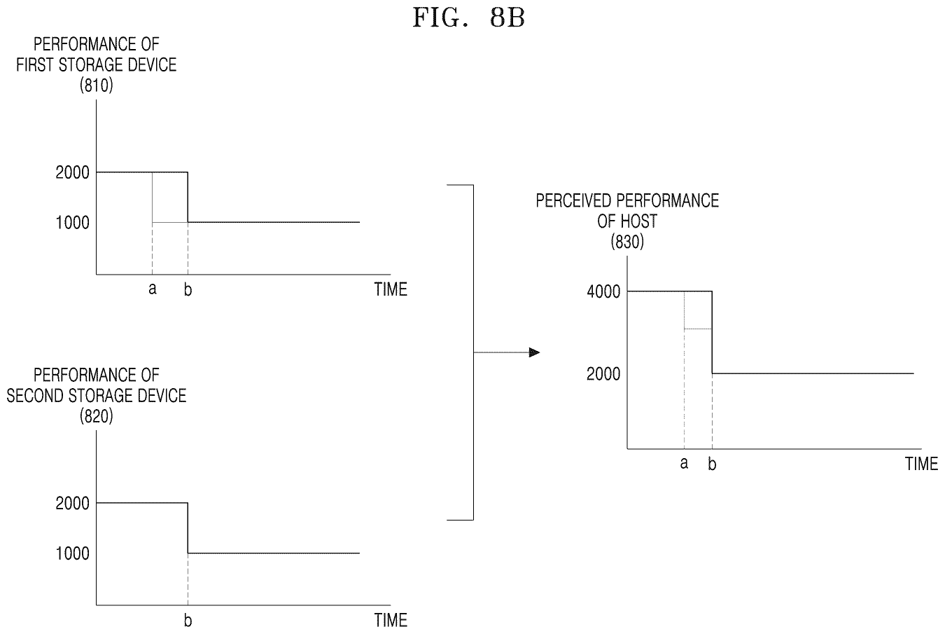

FIG. 8A is a diagram illustrating signal exchange of the memory system 1 in the boost mode, according to some example embodiments, and FIG. 8B is a graph showing performance changes in the boost mode, according to some example embodiments.

Referring to FIG. 8A, the host 20 may transmit commands to the first storage device 100 and the second storage device 200. Because only the memory package 10 is seen at the kernel end of the host 20, the kernel end of the host 20 may issue only a single job dispatch to the memory package 10. However, the file system end of the host 20 may separate and transmit commands according to addresses. For example, at the file system level, a first command CMD 1 corresponding to an address of the first storage device 100 among requests of the host 20 and a second command CMD 2 corresponding to an address of the second storage device 200 among the requests of the host 20 may be generated and transmitted to the memory package 10.

According to some example embodiments, the first storage device 100 and the second storage device 200 may periodically monitor background events. For example, at a time point when a background event is detected in the first storage device 100, the background event may still not be detected in the second storage device 200.

According to some example embodiments, the first storage device 100 may transmit status information to the second storage device 200, which is a peer memory. The first storage device 100 may generate the status information based on the detected background event. The detected background event may be a deferrable background operation. For example, when the first storage device 100 determines execution of GC, the first storage device 100 may generate the status information including the urgency indicator of logic low and transmit the status information to the second storage device 200. Based on receiving the status information from the first storage device 100, which is a peer memory, the second storage device 200 may identify that a background event has been detected by the first storage device 100. In some example embodiments, the second storage device 200 may identify that a background event occurring in the first storage device 100 is a deferrable background operation, based on an urgency indicator of logic low.

According to some example embodiments, the second storage device 200 may monitor a background event in response to reception of the status information. The second storage device 200 may check whether there is a background operation that the second storage device 200 itself is to perform, in response to reception of the status information. As a result of the monitoring or checking by the second storage device 200, the second storage device 200 may not detect a background event.

According to some example embodiments, the second storage device 200 may transmit a response mode of a boost mode to the first storage device 100. Because there is no background operation to be performed, the second storage device 200 may request the first storage device 100 to postpone the background operation. To this end, the second storage device 200 may determine a boost mode for preferentially processing commands (e.g., the first command CMD 1 and the second command CMD 2) from the host 20, and may transmit a response mode indicating the boost mode to the first storage device 100.

According to some example embodiments, the first storage device 100 may postpone a background operation based on the response mode from the second storage device 200. The first storage device 100 may receive the response mode of the boost mode from the second storage device 200, and may postpone a background operation based on the boost mode. The first storage device 100 may synchronize a processing completion time of the second command CMD 2 of the second storage device 200 with a processing completion time of the first command CMD 1 of the first storage device 100 by postponing the background operation and preferentially processing the first command CMD 1 from the host 20. The first storage device 100 may process the postponed background operation after completing processing of the first command CMD 1.

In the above-described example embodiment, the first storage device 100 transmitting the status information to the second storage device 200 by first detecting the background event and the second storage device 200 determining a boost mode and transmitting the boost mode to the first storage device 100 has been described. However, example embodiments are not limited thereto. According to some example embodiments, the second storage device 200 may transmit the status information to the first storage device 100 by first detecting the background event, and the first storage device 100 may determine a boost mode and transmitting the boost mode to the second storage device 200.

Referring to a graph 810 of FIG. 8B showing performance of the first storage device 100, it may be seen that an execution time point of the background operation is postponed from a time point a to a time point b. For example, the first storage device 100 may postpone the execution time point of the background operation to the time point b in order to preferentially process a command from the host 20 by receiving a response mode indicating a boost mode from the second storage device 200. Referring to a graph 820 of FIG. 8B showing performance of the second storage device 200, because background events have not been detected by the second storage device 200, an improved performance (e.g., 2000) may be maintained until the time point b. Referring to a graph 830 of FIG. 8B showing perceived performance of the host 20, the first storage device 100 and the second storage device 200 may process (e.g., in a relatively shorter time duration) and complete the command requested by the host 20 to thereby increase the time for processing the command with an improved performance (e.g., 4000). It may also be seen that step-by-step performance degradation that occurred in FIGS. 5A and 5B is reduced due to the first storage device 100 postponing the background operation.

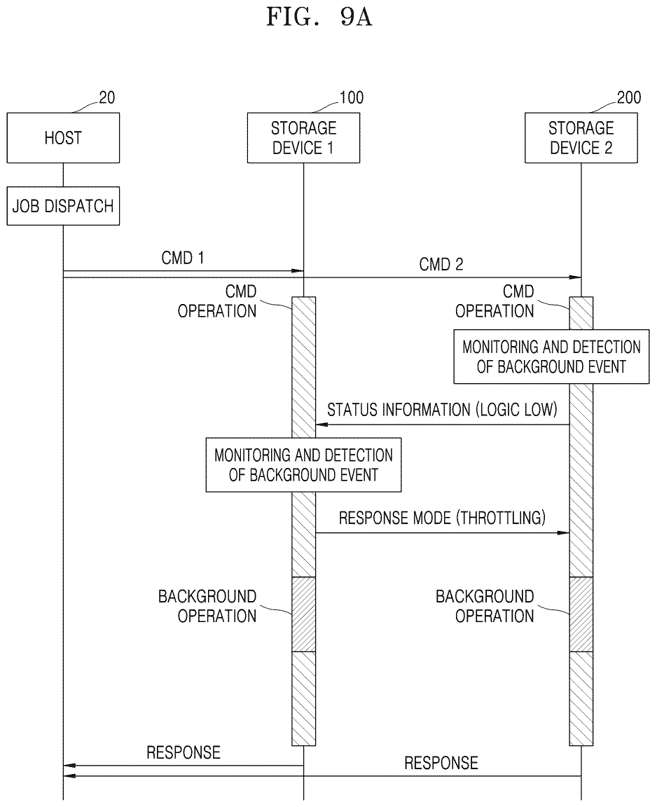

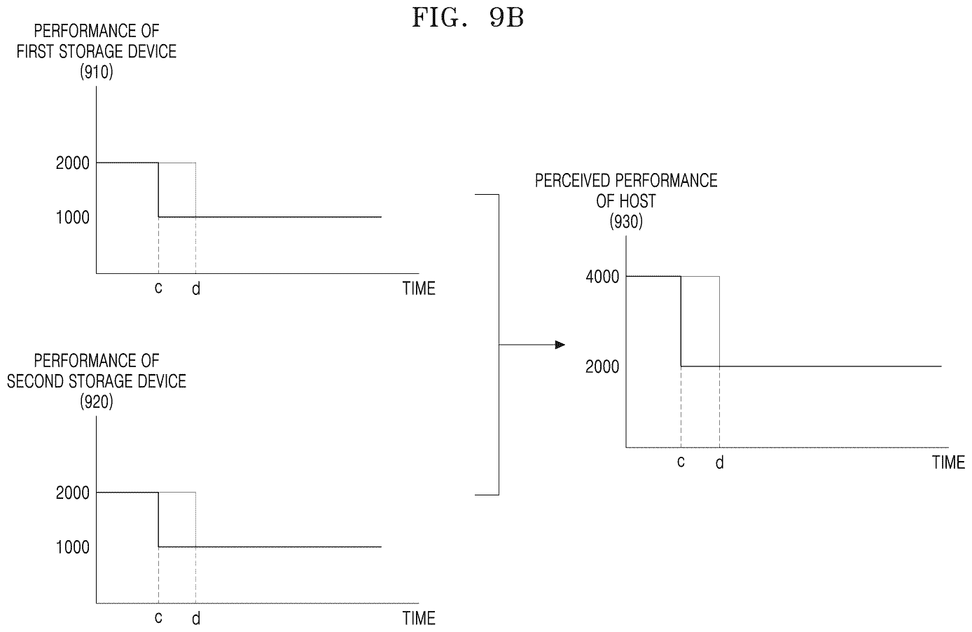

FIG. 9A is a diagram illustrating signal exchange of the memory system 1 in the throttling mode, according to some example embodiments, and FIG. 9B is a graph showing performance changes in the throttling mode, according to some example embodiments.

Referring to FIG. 9A, the host 20 may transmit commands to the first storage device 100 and the second storage device 200. Because only the memory package 10 is seen at the kernel end of the host 20, the kernel end of the host 20 may issue only a single job dispatch to the memory package 10. However, the file system end of the host 20 may separate and transmit commands according to addresses. For example, the file system end may generate a first command CMD 1 corresponding to an address of the first storage device 100 among requests of the host 20 and a second command CMD 2 corresponding to an address of the second storage device 200 among the requests of the host 20 and may transmit the first and second commands CMD 1 and CMD 2 to the memory package 10.

According to some example embodiments, the first storage device 100 and the second storage device 200 may monitor (e.g., periodically or at desired intervals) respective background events. The second storage device 200 may identify that the second storage device 200 is to perform a background operation including at least GC and DTT. For example, at a time point when a background event is detected by the second storage device 200, a background event may still not be detected by the first storage device 100.

According to some example embodiments, the second storage device 200 may transmit status information to the first storage device 100, which is a peer memory. The second storage device 200 may generate the status information based on the detected background event. The detected background event may be a deferrable background operation. For example, when the second storage device 200 determines execution of GC, the second storage device 200 may generate the status information including the urgency indicator of logic low and transmit the status information to the first storage device 100. Based on receiving the status information from the second storage device 200, which is a peer memory, the first storage device 100 may identify that a background event has been detected by the second storage device 200. The first storage device 100 may identify that a background event occurring in the second storage device 200 is a deferrable background operation, based on an urgency indicator of logic low.

According to some example embodiments, the first storage device 100 may monitor (or otherwise check) for its own background event in response to reception of the status information. The first storage device 100 may check whether there is a background operation that the first storage device 100 itself is to perform, in response to reception of the status information. As a result of the monitoring of the background event by the first storage device 100, an executable background event (e.g., a background event that may not be postponed) may be identified.

According to some example embodiments, the first storage device 100 may transmit a response mode indicating the throttling mode to the second storage device 200. Because an executable background event has been identified, the first storage device 100 may request the second storage device 200 to preferentially process the background operation and postpone processing of the command requested by the host 20. To this end, the first storage device 100 may determine a throttling mode for postponing commands (e.g., the first command CMD 1 and the second command CMD 2) from the host 20 and preferentially processing a background operation identified by each of the first and second storage devices 100 and 200, and may transmit a response mode indicating the throttling mode to the second storage device 200.

According to some example embodiments, the second storage device 200 may preferentially process a background operation based on the response mode from the first storage device 100. The second storage device 200 may receive the response mode indicating the throttling mode from the first storage device 100, and may preferentially process a background operation based on the throttling mode. The first storage device 100 and the second storage device 200 may respectively postpone processing of the first and second commands CMD 1 and CMD 2, requested by the host 20, and may preferentially process respective background operations identified by the first storage device 100 and the second storage device 200. The first storage device 100 and the second storage device 200 may synchronize completion time points of the first command CMD 1 and the second command CMD 2 with each other by preferentially processing background operations and processing the first command CMD 1 and the second command CMD 2 later at the same or similar time zone.

In the above-described embodiment, the second storage device 200 transmitting the status information to the first storage device 100 by first detecting the background event and the first storage device 100 determining a throttling mode and transmitting the throttling mode to the second storage device 200 has been described. However, example embodiments are not limited thereto. According to some example embodiments, the first storage device 100 may transmit the status information to the second storage device 200 by first detecting the background event thereof, and the second storage device 200 may determine a throttling mode and transmitting the throttling mode to the first storage device 100.

Referring to a graph 910 of FIG. 9B showing performance of the first storage device 100 and a graph 920 of FIG. 9B showing performance of the second storage device 200, it may be seen that execution time points of the background operations are unified to a time point c. For example, the second storage device 200 may advance the execution time point of the background operation to the time point c in response to reception of a response mode indicating a throttling mode from the first storage device 100. The first storage device 100 may advance the execution time point of the background operation to the time point c in response to determination of a throttling mode. Referring to a graph 930 of FIG. 9B showing performance of the host 20, it may be seen that both of the first storage device 100 and the second storage device 200 preferentially process background operations so that step-by-step performance degradation that occurred in FIGS. 5A and 5B is reduced or limited.

FIG. 10 is a diagram illustrating signal exchange of the memory system 1 in the throttling mode, according to some example embodiments.

Referring to FIG. 10, the host 20 may transmit commands to the first storage device 100 and the second storage device 200. Because only the memory package 10 is seen at the kernel end of the host 20, the kernel end of the host 20 may issue only a single job dispatch to the memory package 10. However, the file system end of the host 20 may separate and transmit commands according to addresses. For example, the file system end may generate a first command CMD 1 corresponding to an address of the first storage device 100 among requests of the host 20 and a second command CMD 2 corresponding to an address of the second storage device 200 among the requests of the host 20 and may transmit the first and second commands CMD 1 and CMD 2 to the memory package 10.

According to some example embodiments, the first storage device 100 and the second storage device 200 may monitor (e.g., periodically or at desired intervals) respective background events. The first storage device 100 may identify that a background operation including at least GC and DTT is to be performed. For example, at a time point when a background event is detected in the first storage device 100, the background event may still not be detected in the second storage device 200.

According to some example embodiments, the first storage device 100 may transmit status information to the second storage device 200, which is a peer memory. The first storage device 100 may generate the status information based on the detected background event. For example, the detected background event may be a nondeferrable background operation (e.g., a background operation that may not be deferred or postponed for performing at a later time). For example, in response to a temperature value of the first storage device 100 exceeding a threshold temperature value, the first storage device 100 may determine that a DTT background is to be performed. The first storage device 100 may generate the status information including the urgency indicator of logic high and transmit the status information to the second storage device 200. Based on receiving the status information from the first storage device 100, which is a peer memory, the second storage device 200 may identify that a background event has been detected by the first storage device 100. The second storage device 200 may identify that a background event occurring in the first storage device 100 is a nondeferrable background operation, based on an urgency indicator of logic high.

According to some example embodiments, the second storage device 200 may monitor (or otherwise check) a background event thereof in response to reception of the status information. The second storage device 200 may check whether there is a background operation that the second storage device 200 itself is to perform, in response to reception of the status information. When no background operations to be performed are identified, the second storage device 200 may additionally monitor (or otherwise check) a preemptive background event. The preemptive background event may represent a background operation that may be performed in advance even when there is no background operation that is to be performed immediately based on a current state. A reason for checking the preemptive background event is that, because a nondeferrable background event has occurred in the first storage device 100, the second storage device 200 may preemptively perform a background operation in order to synchronize operations while the first storage device 100 is performing a background operation.

According to some example embodiments, the second storage device 200 may transmit a response mode indicating the throttling mode to the first storage device 100. The second storage device 200 may transmit, to the first storage device 100, a response mode indicating a throttling mode regardless of a result of the detection of the background event, based on the urgency indicator of logic high. Because the background operation of the first storage device 100 is nondeferrable, the second storage device 200 may determine a throttling mode for postponing commands (e.g., the first command CMD 1 and the second command CMD 2) from the host 20 and preferentially processing a background operation identified by the first and/or second storage devices 100 and 200, and may transmit a response mode indicating the throttling mode to the first storage device 100.

According to some example embodiments, the first storage device 100 may preferentially process a background operation based on the response mode from the second storage device 200. The first storage device 100 may receive the response mode indicating the throttling mode from the second storage device 200, and may preferentially process a background operation based on the throttling mode. The first storage device 100 and the second storage device 200 may postpone processing of the first and second commands CMD 1 and CMD 2, requested by the host 20, respectively, and may preferentially process a nondeferrable background operation identified by the first storage device 100 and a background operation or preemptive background operation identified by the second storage device 200, respectively. The first storage device 100 and the second storage device 200 may synchronize completion time points of the first command CMD 1 and the second command CMD 2 with each other by preferentially processing background operations and processing the first command CMD 1 and the second command CMD 2 later at the same time zone.

In the above-described embodiment, the first storage device 100 transmitting the status information to the second storage device 200 by first detecting the background event and the second storage device 200 determining a throttling mode and transmitting the throttling mode to the first storage device 100 has been described. However, example embodiments are not limited thereto. According to some example embodiments, the second storage device 200 may transmit the status information to the first storage device 100 by first detecting the background event, and the first storage device 100 may determine a throttling mode and transmitting the throttling mode to the second storage device 200.

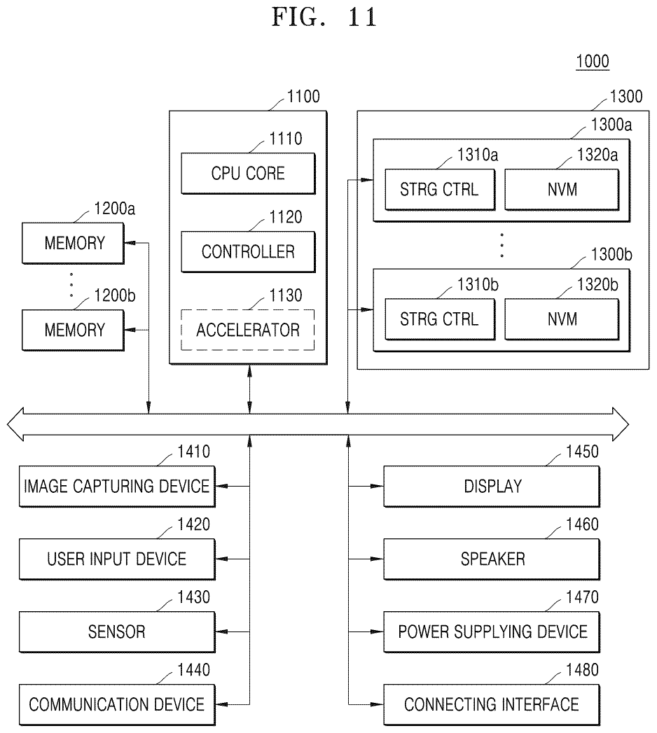

FIG. 11 is a block diagram of a system 1000 including a storage device, according to some example embodiments.

The system 1000 of FIG. 11 may be a mobile system, such as a mobile phone, a smartphone, a tablet personal computer (PC), a wearable device, a health care device, or an Internet of things (IoT) device. However, the system 1000 of FIG. 11 is not limited to the mobile system, and may be a PC, a laptop computer, a server, a media player, an automotive device (such as, a navigation device), etc.

Referring to FIG. 11, the system 1000 may include a main processor 1100, memories 1200a and 1200b, and a storage system 1300, and may further include one or more of an image capturing device 1410, a user input device 1420, a sensor 1430, a communication device 1440, a display 1450, a speaker 1460, a power supplying device 1470, and a connecting interface 1480. Each of the components constituting the system 1000 of FIG. 11, the main processor 1100, the memories 1200a and 1200b, the storage system 1300, the image capturing device 1410, the user input device 1420, the sensor 1430, the communication device 1440, the display 1450, the speaker 1460, the power supplying device 1470, and the connecting interface 1480, may be implemented using the example embodiments described above with reference to FIGS. 1 through 10.

The main processor 1100 may control the overall operation of the system 1000, and operations of other components constituting the system 1000. The main processor 1100 may be implemented as a general-purpose processor, a dedicated or special purpose processor, an application processor (AP), or the like.

The main processor 1100 may include one or more CPU cores 1110, and may further include a controller 1120 for controlling the memories 1200a and 1200b and/or the storage system 1300. According to some example embodiments, the main processor 1100 may further include an accelerator 1130 which is a dedicated or specialized circuit for a high-speed data operation such as an artificial intelligence (AI) data operation. The accelerator 1130 may include a graphics processing unit (GPU), a neural processing unit (NPU), and/or a data processing unit (DPU), and may be implemented as a separate chip physically independent from other components of the main processor 1100.

The memories 1200a and 1200b may be used as a main memory device of the system 1000, and may include volatile memories, such as SRAM and/or DRAM, but may include non-volatile memories, such as flash memory, PRAM, and/or RRAM. The memories 1200a and 1200b may be implemented together with the main processor 1100 in the same package.

The storage system 1300 may include a storage device 1300a and a storage device 1300b. The storage device 1300a and the storage device 1300b may be configured to be included in a single memory package. The storage devices 1300a and 1300b may function as non-volatile storage devices that store data regardless of whether power is supplied or not, and may have a relatively larger storage capacity than the memories 1200a and 1200b. The storage devices 1300a and 1300b may include storage controllers 1310a and 1310b and non-volatile memories (NVMs) 1320a and 1320b for storing data under the control by the storage controllers 1310a and 1310b. The NVMs 1320a and 1320b may include flash memories of a 2-dimensional (2D) structure or a 3-dimensional (3D) Vertical NAND (V-NAND) structure, but may include other types of NVMs such as PRAM and/or RRAM.

The storage system 1300 may be included in the system 1000 in a state of being physically separated from the main processor 1100, or may be implemented together with the main processor 1100 in the same package. The storage system 1300 may be a solid state device (SSD) or a memory card, and thus may be detachably coupled to other components of the system 1000 through an interface such as the connecting interface 1480, which will be described later. The storage system 1300 may be a device that may operate using a protocol such as a UFS, but is not limited thereto.

According to some example embodiments, the storage device 1300a may perform 2-LANE communication with the main processor 1100, and the storage device 1300b may also perform 2-LANE communication with the main processor 1100. At this time, the storage system 1300 may perform 4-LANE communication with the main processor 1100.

The image capturing device 1410 may capture a still image or a moving picture, and may be a camera, a camcorder, and/or a webcam.

The user input device 1420 may receive different types of data input from a user of the system 1000, and may be a touch pad, a keypad, a keyboard, a mouse, and/or a microphone.

The sensor 1430 may detect different types of physical quantities that may be obtained from the outside of the system 1000, and may convert the sensed physical quantities into electrical signals. The sensor 1430 may be a temperature sensor, a pressure sensor, an illuminance sensor, a position sensor, an acceleration sensor, a biosensor, and/or a gyroscope sensor.

The communication device 1440 may transmit and receive signals to and from other devices external to the system 1000 according to various communication protocols. The communication device 1440 may be implemented by including an antenna, a transceiver, and/or a MODEM.

The display 1450 and the speaker 1460 may function as output devices that respectively output visual information and auditory information to a user of the system 1000.

The power supplying device 1470 may appropriately convert power supplied from a battery built into the system 1000 and/or an external power source, and may supply a result of the conversion to each component of the system 1000.

The connecting interface 1480 may provide a connection between the system 1000 and an external device connected to the system 1000 to exchange data with the system 1000. The connecting interface 1480 may be implemented in various interface methods, such as ATA, SATA, e-SATA, an SCSI, an SAS, PCI, PCIe, NVMe, IEEE 1394, a USB, an SD card, an MMC, an eMMC, a UFS, an embedded Universal Flash Storage (eUFS), and a CF card interface.

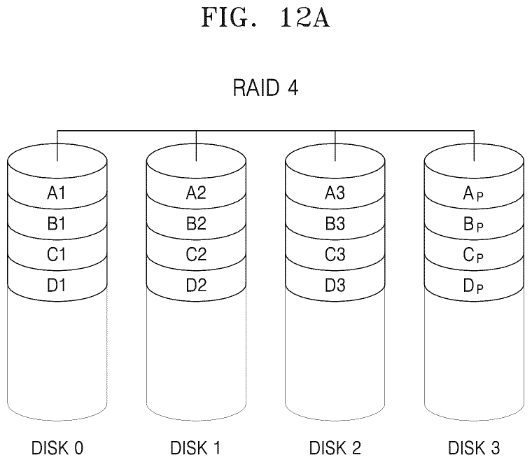

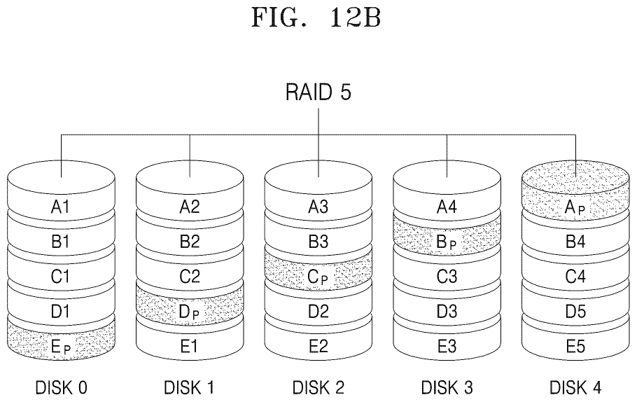

FIG. 12A is a diagram illustrating a Redundant Array of Independent Disk (RAID) implementation according to some example embodiments.

Referring to the above-described example embodiments, a memory package (e.g., the memory package 10 of FIG. 1) is illustrated as including two storage devices (e.g., the first storage device 100 and the second storage device 200 of FIG. 1), but is not limited thereto. According to some example embodiments, the memory package may include a plurality of storage devices. The plurality of storage devices may be configured in the form of a RAID.

Referring to FIG. 12A, the memory package may include four storage devices. Each of first, second, third, and fourth storage devices DISK 0, DISK 1, DISK 2, and DISK 3 may correspond to one storage device (e.g., the first storage device 100 or the second storage device 200 of FIG. 1). In this case, each of the first, second, third, and fourth storage devices DISK 0, DISK 1, DISK 2, and DISK 3 may include a synchronizer (e.g., the first synchronizer 115 of FIG. 1), and the first, second, third, and fourth storage devices DISK 0, DISK 1, DISK 2, and DISK 3 may communicate status information via their respective synchronizers, respectively. The four storage devices may be based on a RAID 4 level. For example, the first, second, and third storage devices DISK 0, DISK 1, and DISK 2 may distribute and store user data received from a host (e.g., the host 20 of FIG. 1). User data A may be distributed into data A1 stored in the first storage device DISK 0, data A2 stored in the second storage device DISK 1, and data A3 stored in the third storage device DISK 2. In addition, according to the RAID 4 level, the fourth storage device DISK 3 may store parity information (e.g., data A_{P}) regarding the user data A. The fourth storage device DISK 3 may detect a background event. For example, the fourth storage device DISK 3 may generate the parity information regarding the user data A. A parity calculation may cause a bottleneck and result in a slowdown. In this case, when the fourth storage device DISK 3 generates status information and shares the status information with the first through third storage devices DISK 0 through DISK 2 as in the above-described example embodiment, the inefficiency period according to the comparative example of FIG. 4 may be reduced or limited, and an overall response speed of the plurality of storage devices based on the RAID 4 level may be increased.

FIG. 12B is a diagram illustrating a RAID implementation according to some example embodiments.

Referring to FIG. 12B, the memory package may include five storage devices. Each of first, second, third, fourth, and fifth storage devices DISK 0, DISK 1, DISK 2, DISK 3, and DISK 4 may correspond to one storage device (e.g., the first storage device 100 or the second storage device 200 of FIG. 1). In this case, each of the first, second, third, fourth, and fifth storage devices DISK 0, DISK 1, DISK 2, DISK 3, and DISK 4 may include a synchronizer (e.g., the first synchronizer 115 of FIG. 1), and the first, second, third, fourth, and fifth storage devices DISK 0, DISK 1, DISK 2, DISK 3, and DISK 4 may communicate status information via their respective synchronizers, respectively. The five storage devices may be based on a RAID 5 level. Four of the five storage devices may be configured in units of blocks, and parity information may be stored in the remaining storage device. The storage device where the parity information is stored in units of blocks may be changed. For example, the first, second, third, and fourth storage devices DISK 0, DISK 1, DISK 2, and DISK 3 may distribute and store user data received from a host (e.g., the host 20 of FIG. 1). User data A may be distributed into data A1 stored in the first storage device DISK 0, data A2 stored in the second storage device DISK 1, data A3 stored in the third storage device DISK 2, and data A4 stored in the fourth storage device DISK 3. In addition, according to the RAID 5 level, the fifth storage device DISK 4 may store parity information (e.g., data A_{P}) regarding the user data A. In writing of a next block, the fourth storage device DISK 3 may store parity information (e.g., data B_{P}) regarding user data B.

According to some example embodiments, the fifth storage device DISK 4 may detect a background event. For example, the fifth storage device DISK 4 may generate the parity information regarding the user data A. A parity calculation may cause a bottleneck and result in a slowdown. In this case, as in the above-described example embodiment, the fifth storage device DISK 4 may generates status information and share the status information with the first through fourth storage devices DISK 0 through DISK 3. In each block, a storage device that stores parity information may detect a background event and share status information. However, example embodiments are not limited thereto, and it will be apparent that, when a background event, such as DTT, occurs in a storage device that stores user data rather than a storage device that stores parity information, the storage device that stores user data may generate and share status information. Accordingly, the inefficient period discussed above may be reduced or otherwise limited, and an overall response speed of the plurality of storage devices based on the RAID 5 level may be improved.

In the above-described example embodiment, the RAID 4 levels and the RAID 5 level are illustrated, but example embodiments are not limited thereto. According to some example embodiments, the discussion above may be equally applicable to RAID 6 level and nested RAIDs (e.g., RAID 0+1, RAID 1+0, RAID 5+0, RAID 6+0, and RAID 10+0).

As described herein, any devices, systems, modules, portions, units, controllers, circuits, and/or portions thereof according to any of the example embodiments, and/or any portions thereof (including, without limitation, the memory system 1, the memory package 10, the host 20, the first storage device 100, the second storage device 200, the first controller 110, the second controller 210, the first memory device 120, the second memory device 220, the processor 111, the flash translation layer (FTL) 112, the memory 113, the interconnect circuit 114, the first synchronizer 115, the memory interface (IF) circuit 116, the background operation manager 310, the peer communicator 320, the main processor 1100, the memories 1200a and 1200b, the storage system 1300, the image capturing device 1410, the user input device 1420, the sensor 1430, the communication device 1440, the display 1450, the speaker 1460, the power supplying device 1470, the connecting interface 1480, CPU cores 1110, the controller 1120, the accelerator 1130, the storage controllers 1310a and 1310b, the non-volatile memories (NVMs) 1320a and 1320b, the storage devices of the RAID 4 and RAID 5, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A memory package comprising:
a first storage device including a first controller configured to receive a first command; and
a second storage device including a second controller configured to receive a second command, wherein
the first controller is configured to monitor a first background event of the first storage device, and, in response to detecting the first background event, generate status information indicating detection of the first background event and transmit the status information to the second controller, and
the second controller is configured to receive the status information from the first controller, monitor a second background event of the second storage device based on the received status information, generate a response mode indicating either a boost mode or a throttling mode based on a result of the monitoring, and transmit the response mode to the first controller.

2. The memory package of claim 1, wherein the first storage device and the second storage device are configured to communicate based on a Universal Flash Storage (UFS) interface.

3. The memory package of claim 1, wherein each of the first background event and the second background event corresponds to either garbage collection (GC) or device thermal throttling (DTT).

4. The memory package of claim 1, wherein
in response to the second background event being detected, the second controller is configured to generate the response mode indicating the throttling mode and transmit the response mode to the first controller, and
in the throttling mode, the first controller is configured to postpone processing of the first command and preferentially process the detected first background event and the second controller is configured to postpone processing of the second command and preferentially processes the second background event.

5. The memory package of claim 1, wherein
in response to the second background event not being detected, the second controller is configured to generate the response mode indicating the boost mode and transmit the response mode to the first controller, and
in the boost mode, the first controller is configured to postpone processing of the detected first background event and preferentially process the first command.

6. The memory package of claim 1, wherein the status information includes an urgency indicator that indicates whether the detected first background event is deferrable.

7. The memory package of claim 6, wherein,
in response to determining that the detected first background event is nondeferrable, the first controller is configured to transmit the status information including the urgency indicator of logic high to the second controller,
the second controller is configured to, in response to the second background event not being detected, monitor a preemptive background event according to the urgency indicator of logic high, generate the response mode indicating the throttling mode, and transmit the response mode to the first controller, and
in the throttling mode, the first controller is configured to postpone processing of the first command and preferentially process the detected first background event and the second controller is configured to postpone processing of the second command and preferentially process the preemptive background event.

8. An operation method of a memory package, the operation method comprising:
receiving a first command for a first storage device included in the memory package and a second command for a second storage device included in the memory package;
monitoring a first background event of the first storage device by a first controller of the first storage device;
in response to detecting the first background event, generating status information indicating detection of the first background event and transmitting the status information to a second controller of the first storage device;
receiving the status information from the first controller by the second controller;
monitoring a second background event of the second storage device based on the received status information; and
based on a result of the monitoring, generating a response mode indicating either a boost mode or a throttling mode and transmitting the response mode to the first controller.

9. The operation method of claim 8, wherein the first storage device and the second storage device are configured to communicate based on a Universal Flash Storage (UFS) interface.

10. The operation method of claim 8, wherein each of the first background event and the second background event corresponds to either garbage collection (GC) or device thermal throttling (DTT).

11. The operation method of claim 8, wherein
the generating of the response mode and the transmitting of the response mode to the first controller comprises generating, by the second controller, the response mode indicating the throttling mode and transmitting, by the second controller, the response mode to the first controller, in response to detecting the second background event, and
in the throttling mode, the first controller postpones processing of the first command and preferentially processes the detected first background event and the second controller postpones processing of the second command and preferentially processes the second background event.

12. The operation method of claim 8, wherein
the generating of the response mode and the transmitting of the response mode to the first controller comprises generating, by the second controller, the response mode indicating the boost mode and transmitting, by the second controller, the response mode to the first controller, in response to the second background event not being detected, and
in the boost mode, the first controller postpones processing of the detected first background event and preferentially processes the first command.

13. The operation method of claim 8, wherein the status information includes an urgency indicator for indicating whether the detected first background event is deferrable.

14. The operation method of claim 13, wherein
the generating of the status information and the transmitting of the status information to the second controller comprises, in response to determining that the detected first background event is nondeferrable, transmitting, by the first controller, the status information including the urgency indicator of logic high to the second controller,
the generating of the response mode and the transmitting of the response mode to the first controller further comprises:
in response to the second background event not being detected, monitoring, by the second controller, a preemptive background event according to the urgency indicator of logic high; and
generating the response mode indicating the throttling mode and transmitting the response mode to the first controller, and
in the throttling mode, the first controller postpones processing of the first command and preferentially processes the detected first background event and the second controller postpones processing of the second command and preferentially processes the preemptive background event.

15. A memory controller, comprising:
a processor configured to process a command;
a background operation manager configured to monitor an occurrence of a background event; and
a peer communicator configured to transmit status information indicating whether the background event has occurred, or to receive a response mode indicating either a boost mode or a throttling mode,
wherein
the background operation manager is configured to:
generate state information and provide the state information, in response to detecting the background event; and
preferentially process either the detected background event or the command according to the received response mode.

16. The memory controller of claim 15, wherein the background event corresponds to either garbage collection (GC) or device thermal throttling (DTT).

17. The memory controller of claim 15, wherein the throttling mode includes postponing processing of the command and preferentially processing the detected background event.

18. The memory controller of claim 15, wherein the boost mode includes postponing processing of the detected background event and preferentially processing the command.

19. The memory controller of claim 15, wherein
the status information includes an urgency indicator for indicating whether the detected background event is deferrable, and
the background operation manager is configured to, in response to determining that the detected background event is nondeferrable, generate the status information including the urgency indicator of logic high.

20. The memory controller of claim 19, wherein the background operation manager is configured to, in response to reception of the status information including the urgency indicator of logic high, monitor a preemptive background event, generate the response mode indicating the throttling mode, and transmit the response mode.
